(19) United States
(12) Patent Application Publication
(10) Pub. No.: US 2026/0052526 A1
(43) Pub. Date: Feb. 19, 2026

(54) PANEL INFORMATION REPORT BASED ON UE BEAM PREDICTION

(71) Applicant: QUALCOMM Incorporated, San Diego, CA (US)

(72) Inventors: Tianyang BAI, Mountain View, CA (US); Yan ZHOU, San Diego, CA (US); Hua WANG, Basking Ridge, NJ (US); Junyi LI, Greentown, PA (US); Taesang YOO, San Diego, CA (US); Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 19/103,197

(22) PCT Filed: Sep. 22, 2022
(86) PCT No.: PCT/CN2022/120398

§ 371 Date: Feb. 11, 2025

(51) Int. Cl. H04W 72/044; H04L 5/00; H04W 72/11

(52) U.S. Cl. CPC H04W 72/046; H04L 5/0044; H04W 72/11

(57) ABSTRACT

Apparatus, methods, and computer program products for wireless communication with beam prediction are provided. An example method may include transmitting, for a second network entity, capability information indicative of one or more capabilities associated with at least one panel of the first network entity. The example method may further include predicting a spatial filter change associated with the at least one panel of the first network entity. The example method may further include transmitting, for the second network entity, spatial filter change information indicative the spatial filter change associated with the at least one panel. The example method may further include communicating with the second network entity based on the spatial filter change.

### TECHNICAL FIELD

The present disclosure relates generally to communication systems, and more particularly, to wireless communication systems with beam prediction.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity (such as a user equipment (UE)) are provided. The apparatus may include a memory and at least one processor coupled to the memory. The at least one processor may be configured to transmit, for a second network entity, capability information indicative of one or more capabilities associated with at least one panel of the first network entity. The at least one processor may be further configured to predict a spatial filter change associated with the at least one panel of the first network entity. The at least one processor may be further configured to transmit, for the second network entity, spatial filter change information indicative of the spatial filter change associated with the at least one panel. The at least one processor may be further configured to communicate with the second network entity based on the spatial filter change.

In another aspect of the disclosure, a method, a computer-readable medium, and an apparatus at a second network entity (such as a UE or a base station) are provided. The apparatus may include a memory and at least one processor coupled to the memory. The at least one processor may be configured to receive capability information indicative of one or more capabilities associated with at least one panel of a first network entity. The at least one processor may be further configured to receive spatial filter change information indicative of a predicted spatial filter change associated with the at least one panel of the first network entity. The at least one processor may be further configured to communicate with the first network entity based on the predicted spatial filter change.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating communication between UEs with multiple panels and a network entity.

FIG. 5 is a diagram illustrating example communications between a network entity and a UE.

FIG. 6A is a diagram illustrating example UE beam prediction.

FIG. 6B is a diagram illustrating example results of UE beam prediction.

FIG. 7 is a diagram illustrating example communications between a network entity and a UE.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NRBS, 5GNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

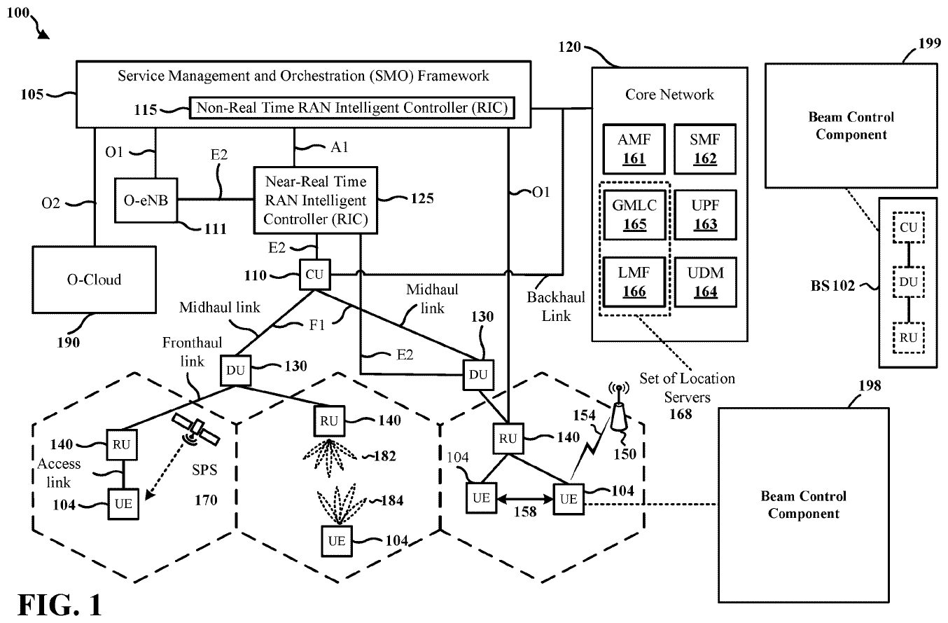

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualize d network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/NIL models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a beam control component 198. In some aspects, the beam control component 198 may be configured to transmit, for a second network entity, capability information indicative of one or more capabilities associated with at least one panel of the first network entity. In some aspects, the beam control component 198 may be further configured to predict a spatial filter change associated with the at least one panel of the first network entity. In some aspects, the beam control component 198 may be further configured to transmit, for the second network entity, spatial filter change information indicative of the spatial filter change associated with the at least one panel. In some aspects, the beam control component 198 may be further configured to communicate with the second network entity based on the spatial filter change.

In certain aspects, the base station 102 may include a beam control component 199. In some aspects, the beam control component 199 may be configured to receive capability information indicative of one or more capabilities associated with at least one panel of a first network entity. In some aspects, the beam control component 199 may be further configured to receive spatial filter change information indicative of a predicted spatial filter change associated with the at least one panel of the first network entity. In some aspects, the beam control component 199 may be further configured to communicate with the first network entity based on the predicted spatial filter change.

Although the following description may be focused on 5GNR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from abase station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from abase station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

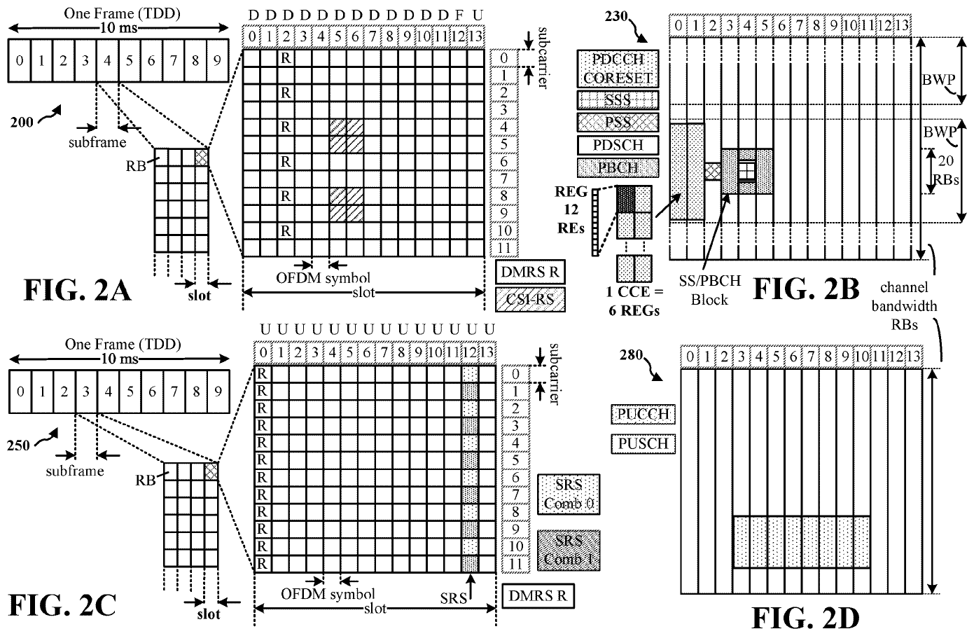

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | |
|---|---|---|
| μ | Δf = 2^{μ} · 15[kHz] | Cyclic pre fix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

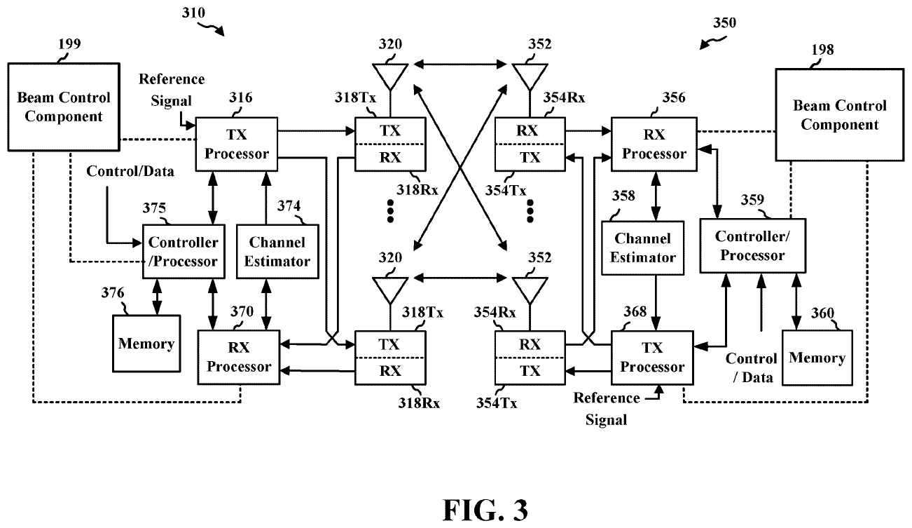

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with beam control component 198 of FIG. 1.

At least one of the TX processor 316, the RX processor 370, and the controller/processor 375 may be configured to perform aspects in connection with beam control component 199 of FIG. 1.

As used herein, the term “beam” or “spatial filter” may be used to refer to a spatial filter for transmitting or receiving a transmission. A spatial filter may be applied while transmitting or receiving a transmission and applying a spatial filter may include applying a same direction, same shape, or same power of the beam. An RF chain at a transmitter of a network entity (such as a base station) may be one or more modules or components that processes digital signal as an input and process the digital signal to an analog signal that may be ready for an antenna to transmit to another device. By way of example, an RF chain may take digital signal as an input, process the digital signal using a digital to analog converter, use a low pass filter to process an output of the digital to analog converter, perform frequency up-convert based on a local oscillator, amplify the signal using a power amplifier, filter the signal based on a band pass filter, and process the signal based on phase shifters. A network entity, such as a base station, may use a set of antennas connected to multiple IQ modulators or IF modulators and the set of antennas may come from different panels or different remote radio head (RRH) units associated with a same network entity. An RRH unit may be a remote radio transceiver that connects to an operator radio control panel via electrical or wireless interface. An RRH unit may be used for extending range of a network entity and different RRH units may be located in different physical locations while being considered part of a same network entity (e.g., a same gNB). While transmitting or receiving a transmission, a spatial filter may be applied at one or more panels of a network entity or a UE. As used herein, the term “panel” may refer to a physical or virtual entity associated with one or more antenna elements or antenna panels at a UE or a base station. In some aspects, each panel may be associated with a respective spatial filter. In some aspects, a respective spatial filter associated with a panel may change. Each panel may be identified by a panel identifier (ID) which may be a RS resource set ID, an antenna ID, or an antenna group ID.

In response to different conditions, beams may be switched. For example, a transmission configuration indication (TCI) state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCHDM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS. QCL may be of different types. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam).

In some wireless communication systems, beam management which may include beam prediction in time or spatial domain for overhead and latency reduction and beam selection accuracy improvement may be used. For example, by predicting a spatial filter used at a later time (e.g., due to movement of the UE or change in environment), a UE and a base station may adjust accordingly to reduce latency in applying the spatial filter. Artificial intelligence or machine learning (ML) (e.g., such as reinforced learning (RL)) may be used for beam predicting. Aspects provided herein may use capability indication and configuration procedures (training/inference), validation and testing procedures, and management of data and AI/ML model to facilitate beam prediction. Aspects provided herein may provide panel related signaling to enable report of predicted panel changes.

A ML module may be used at a UE for beam prediction for communications, such as mmW communications. In some aspects, a ML module may facilitate predict or select UE side beam and beam of the other side (e.g., a network entity such as a base station or another UE). In some wireless communication systems, multi-panel UE for MIMO may be used. A UE may report activated panels and related capability (such as a maximum number of supported ports) to a network entity. A network entity or another UE may indicate a panel for transmission or reception of UL, DL, or SL data or signal.

UE side beam prediction may also include predicting a panel change at a future time. For example, due to UE local rotation or movement, an established Rx beam may fall into a spatial coverage of a new UE beam associated with a different panel. In another example, for flipping UE or UE with flexible display, the antenna panel position may change when the UE is folded or unfolded and a new panel may be accordingly activated or used for receiving or transmitting a signal. A UE may track changes related to beam prediction based on measuring RS (such as SSB, CSI-RS, or the like), data from a RF sensor or a camera to track nearby objects (e.g., to track rotation or movement of the UE or movement of other objects), an IMU sensor (e.g., to track rotation), or a sensor or a switch for tracking folding/unfolding of the UE.

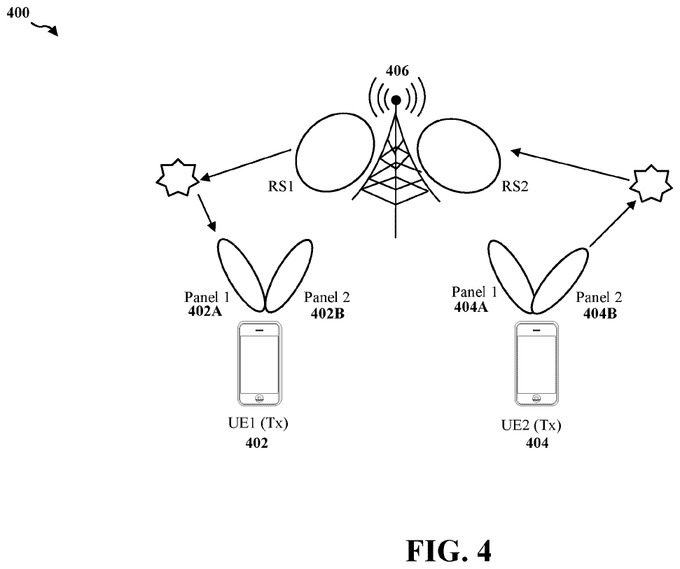

FIG. 4 is a diagram 400 illustrating communication between UEs with multiple panels and a network entity. As illustrated in FIG. 4, a UE 402 may be associated with a first panel 402A and a second panel 402B at the UE 402 and a UE 404 may be associated with a first panel 404A and a second panel 404B at the UE 404. The UE 402 may be in communication with a network entity 406 using the panel 402A and the UE 404 may be in communication with the network entity 406 using the second panel 404B. The panel 402A may be associated with a panel ID based on an ID of RS 1 and the second panel 404B may be associated with a panel ID based on an ID of RS 2. The UE 402 and the UE 404 may report to the network entity 406 about the activation or deactivation of panels along with a capability associated with the UE (such as a maximum number of MIMO layers per panel). The network entity 406 may configure the UE 402 or the UE 404 to transmit or receive a channel or RS via a particular panel, such as the panel 402A and the second panel 404B. When a UE (such as the UE 402 or the UE 404) sends CSI report, the UE may also indicate the associated panel for the measurement results in the CSI reporting.

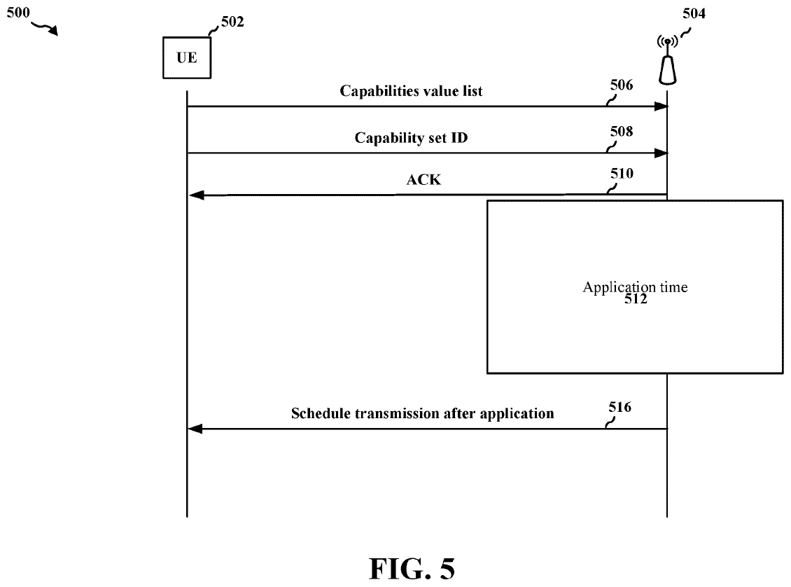

FIG. 5 is a diagram 500 illustrating example communications between a network entity 504 and a UE 502. In some aspects, the network entity 504 may be a network node. In some aspects, the network node may be implemented as an aggregated base station, a disaggregated base station, an integrated access and backhaul (IAB) node, a relay node, a sidelink node, or the like. In some aspects, the network entity 504 may be implemented in an aggregated or monolithic base station architecture, or alternatively, in a disaggregated base station architecture, and may include one or more of a CU, a DU, an RU, a Near-Real Time (Near-RT) RAN Intelligent Controller (RIC), or a Non-Real Time (Non-RT) RIC. As illustrated in FIG. 5, the UE 502 may transmit a capabilities value list 506 to the network entity 504. In some aspects, the capabilities value list 506 may represent a list of UE capability value sets where each UE capability value set include a maximum supported number of SRS ports. For any two different value sets, at least one capability value may be different or identical. In some aspects, the UE capability value set may be common across all BWPs/CCs in a same band or band combination. In some aspects, the UE capability value set may be not common across all BWPs/CCs in a same band or band combination. In some aspects, to facilitate UE-initiated panel activation and selection via UE reporting, a list of UE capability value sets, the correspondence between each reported CSI-RS and/or SSB resource index and one of the UE capability value sets in the reported the capabilities value list 506 may be determined by the UE. In some aspects, the capabilities value list 506 may be transmitted to the network entity 504 in a beam reporting instance. In some aspects, the capabilities value list 506 may be associated with an index of corresponding UE capability value set which may be reported along with a pair of SSB rank indicator (RI) or CSI-RS resource indicator (CRI) and physical layer (L1) reference signal received power (RSRP) or signal to interference and noise ratio (SINR) in a beam reporting uplink control information (UCI) or sidelink control information (SCI) and may be based on down select between: (1) UE can report one index for all the reported CRIs/SSBRIs in one beam reporting or (2) UE can report one index for each reported CRI/SSBRI in one beam reporting. In some aspects, the capabilities value list 506 may be reported periodically, semi-persistently, or aperiodically. In some aspects, semi-persistent (SP) or aperiodic (A) reporting may be triggered when periodic (P) reporting is configured. In some aspects, the capabilities value list 506 may be a list of maximum number of supported SRS ports. For example, the capabilities value list 506 may indicate set #0={1 port}, set #1={2 ports}. In some aspects, in a DL or SL beam report, the UE 502 may report a capability value set ID (e.g., capability set ID 508) corresponding to an intended port number or ID for a reported DL RS. For example, the UE 502 may report that set #0 may be associated with SSB #5, or the like.

In some aspects, there may be acknowledgement mechanism of the reported correspondence from network entity 504 to the UE 502. The network entity 504 may transmit an ACK 510 for the capability set ID 508. In some aspects, the network entity 504 may also update one or more configurations based on the capability set ID 508. In some aspects, after an application time 512 after the ACK 510, the network entity 504 may schedule transmission (e.g., 516) such as SRS or PUSCH (e.g., for contention based transmission) on a corresponding TCI state (e.g., associated with a beam), based on the reported capability (e.g., 506 or 508).

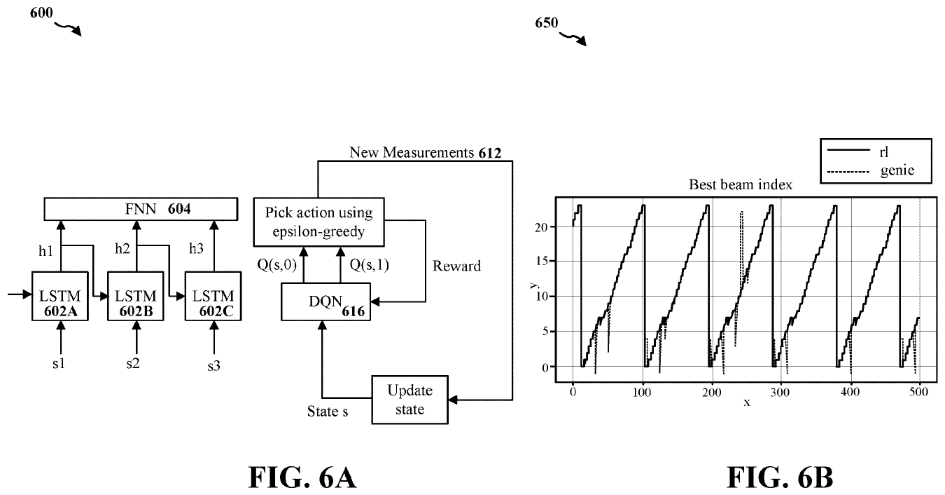

FIG. 6A is a diagram 600 illustrating example UE beam prediction. A UE may predict Rx beam based on measuring SSBs without sensors. In some aspects, the input (e.g., based on using a long short-term memory (LSTM) module 602A, a LSTM module 602B, and a LSTM module 602C and a feedforward neural network (FNN) 604) may be past measured SSB RSRP and the output may be Rx beam ID. The training data may be RSRPs at different locations with different speeds of rotation. In some aspects, a deep Q learning (DQN) module 616 may be used. The new measurements 612 may be measurement based on SSBs. The state may be a beam ID. FIG. 6B is a diagram 650 illustrating example results of UE beam prediction. In FIG. 6B, the horizontal axis may represent time and the vertical axis may represent beam ID. As illustrated in FIG. 6B, the predicted beam changes may be generally accurate.

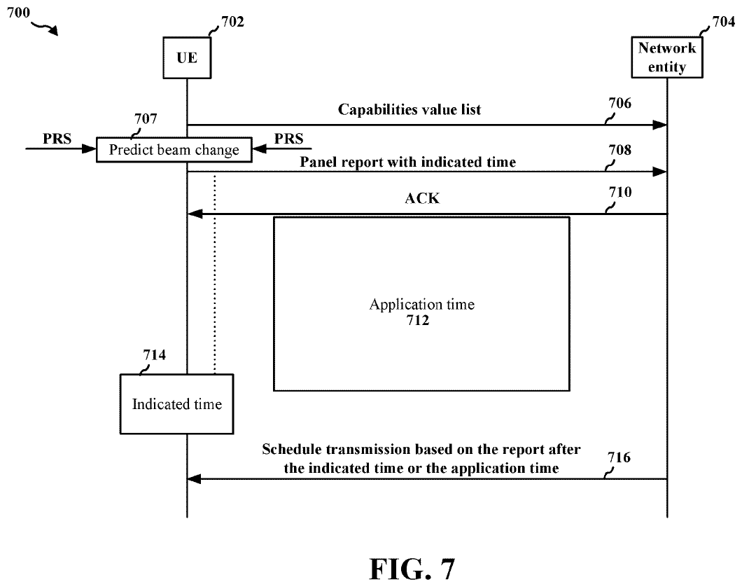

FIG. 7 is a diagram 700 illustrating example communications between a network entity 704 and a UE 702. In some aspects, the network entity 704 may be a network node. In some aspects, the network node may be implemented as an aggregated base station, a disaggregated base station, an integrated access and backhaul (IAB) node, a relay node, a sidelink node, or the like. In some aspects, the network entity 704 may be implemented in an aggregated or monolithic base station architecture, or alternatively, in a disaggregated base station architecture, and may include one or more of a CU, a DU, an RU, a Near-Real Time (Near-RT) RAN Intelligent Controller (RIC), or a Non-Real Time (Non-RT) RIC. As illustrated in FIG. 7, the UE 702 may transmit a capabilities value list 706 to the network entity 704. In some aspects, the capabilities value list 706 may represent a list of UE capability value sets where each UE capability value set include a maximum supported number of SRS ports. For any two different value sets, at least one capability value may be different or identical. In some aspects, the UE capability value set may be common across all BWPs/CCs in a same band or band combination. In some aspects, the UE capability value set may be not common across all BWPs/CCs in a same band or band combination. In some aspects, to facilitate UE-initiated panel activation and selection via UE reporting, a list of UE capability value sets, the correspondence between each reported CSI-RS and/or SSB resource index and one of the UE capability value sets in the reported the capabilities value list 706 may be determined by the UE. In some aspects, the capabilities value list 706 may be transmitted to the network entity 704 in a beam reporting instance. In some aspects, the capabilities value list 706 may be associated with an index of corresponding UE capability value set which may be reported along with a pair of SSB rank indicator (RI) or CSI-RS resource indicator (CRI) and physical layer (L1) reference signal received power (RSRP) or signal to interference and noise ratio (SINR) in a beam reporting uplink control information (UCI) or sidelink control information (SCI) and may be based on down select between: (1) UE can report one index for all the reported CRIs/SSBRIs in one beam reporting or (2) UE can report one index for each reported CRI/SSBRI in one beam reporting. In some aspects, the capabilities value list 706 may be reported periodically, semi-persistently, or aperiodically. In some aspects, semi-persistent or aperiodic reporting may be triggered when periodic reporting is configured. In some aspects, the capabilities value list 706 may be a list of maximum number of supported SRS ports. For example, the capabilities value list 706 may indicate set #0={1 port}, set #1={2 ports}.

In some aspects, the capabilities value list 706 may include a representation of a time offset (between a report time of the capabilities value list 706 and a future applicable time (e.g., of the indicated time 714)). In some aspects, the capabilities value list 706 may include a representation of a reserved index that indicates that the reported change corresponds to current time. In some aspects, the capabilities value list 706 may include a representation of one or more (e.g., between one to a maximum number of panels) panel IDs. In some aspects, the capabilities value list 706 may include a representation of one or more configured periods of time. In some aspects, the capabilities value list 706 may include a representation of one or more supported SRS ports or one or more supported DL/SL ports or MIMO layers. In some aspects, the capabilities value list 706 may include a representation of one or more beam switch times for changing a spatial filter or panel.

At 707, the UE 702 may predict (which may be otherwise referred to as “estimate”) a beam change based on internal sensors, camera, or receiving RSs from the network entity 704 or another UE (e.g., such as PRS 707 from the network entity 704 or another UE for positioning or a CSI-RS, an SSB, or the like). After predicting at 707, the UE 702 may transmit a panel report 708 with an indicated time to the network entity 704. In some aspects, the UE 702 may predict that at a future time, a predicted Tx/Rx beam may be associated with a different panel than a currently used panel for the Tx/Rx beam. In some aspects, the UE 702 may predict a panel change related to a UL transmission, a DL transmission, or an SL transmission. In some aspects, panel changes may include an activated panel list change, a panel related capability changes (e.g., supported port changes due to battery state change), panel switching time information, or RS and panel association change. In some aspects, the network entity 704 may configure the UE 702 to associate a RS or a channel with a panel. In some aspects, the UE 702 may report a requested association between channel or RS and panel to the network entity 704. At 707, the UE may predict a panel change (e.g., and report, recommend, or request a new association) in panel report 708 with indicated time. In some aspects, at 707, panel related capability changes may be predicted to occur even when the panel associated with RS or channel may not change. For example, at a future time such as the indicated time 714, fewer antenna elements may be activated at the UE 702 (e.g., due to battery state), and fewer MIMO layers may be supported accordingly. In some aspects, the UE 702 may not explicitly report a change in panel ID, but report a change in the capability after switching panel. For example, the network entity 704 may not configure the UE 702 to report an explicit panel ID but rather capability associated with the panel. In some aspects, when it's predicted that panel changes may cause a capability change, then UE 702 may report the new capability. In some aspects, the panel report 708 may indicate a panel switching time. Panel switching time may take longer or shorter, the UE 702 may indicate a period of time when the panel switch is performed. The network entity 704 may assume the related channel/RS to the panel switching may not be received/monitored during the beam switching time. In some aspects, the panel report 708 may indicate a panel blackout time. In some aspects, certain panel may experience some (periodic) black-out time, e.g., due to UE rotation, for some RS, the UE 702 may indicate a time period when a panel can or cannot be used to communicate with a RS or a channel. The panel report 708 may include a periodic pattern associated with the blackout time. In some aspects, the panel report 708 may also include a recommended beam change at the network entity 704.

In some aspects, the panel report 708 may be transmitted in PUCCH such as aperiodic, periodic, or semi-persistent, L1 beam report occasion(s). In some aspects, the panel report 708 may be transmitted in PSCCH. In some aspects, the panel report 708 may indicate an index of a feature that may points to a value in the capabilities value list 706. In some aspects, the panel report 708 may include future time stamp(s) or a time period (e.g., blackout period) (associated with the indicated time 714). In some aspects, the panel report 708 may indicate other changes besides SRS port changes such as change in association of SSB or CSI RS ID and panel ID to report panel association change. In some aspects, the indicated time 714 may represent a predicted time or time period where the changes predicted at 707 and reported in the panel report 708 may take effect. In some aspects, the changes predicted at 707 and reported in the panel report 708 may take effect after a latter of the indicated time 714 or an application time 712 after the ACK 710. In some aspects, the network entity 504 may transmit an ACK 710 for the panel report 708. In some aspects, the network entity 704 may also update one or more configurations based on the panel report 708. In some aspects, after an application time 712, the network entity 704 may schedule transmission (e.g., 718) such as SRS or PUSCH (e.g., for contention based transmission) on a corresponding TCI state (e.g., associated with a beam), based on the panel report 708.

In some aspects, the panel report 708 may be transmitted in medium access control (MAC) control element (MAC-CE). In some aspects, the MAC-CE may be multiplexed in a UL Tx, such as an existing UL grant. In some aspects, the MAC-CE may be multiplexed in a SL Tx. In some aspects, the MAC-CE may be sent in UL grant requested by UE via SR. In some aspects, for PUCCH based SR, the SR may be a normal SR or a special SR. In some aspects, if PUCCH based SR is not configured, the UE 702 may initiate a RACH procedure and transmit the MAC-CE in an UL grant associated with the RACH procedure, e.g., in a message A (MsgA) or a message 3 (Msg3) in 2-Step or 4-step RACH. In some aspects, the MAC-CE may include a time stamp, e.g., time stamp indicates the corresponding applicable time of capability changes, a reserved index to indicate the report corresponds to current time, a panel ID, mapping between the beam indication ID/RS ID and panel ID, indication of available or blackout time (starting/ending time stamp) of a panel, or capability of a panel such as a maximum number of DL/UL/SL ports or MIMO ranks.

In some aspects, the capabilities value list 706 or the panel report 708 may be associated with one or more signals, such as P/SP SRS, configured grant (CG) PUSCH, P/SP PUCCH, SPS PDSCH, P/SP CSI-RS or tracking reference signal (TRS), or the like. In some aspects, one or more channels or RSs may be scheduled after the change reported in the panel report 708 takes effect while their respective scheduling signaling may be sent before capability change. In some aspects, if the updated capabilities as predicted at 707 and report in the panel report 708 cannot satisfy configuration of one or more signals (e.g., such as P/SP SRS, CG PUSCH was scheduled for 2 ports, but panel capability change indicates that the updated panel supports 1 port), the signal may be: (1) canceled or deactivated until further update, (2) transmitted based on UE implantation or based on a configured rule changing the transmission (such as SRS/PUSCH transmission changed to be based on a transmit precoding matrix index (TPMI) of the lowest ID port).

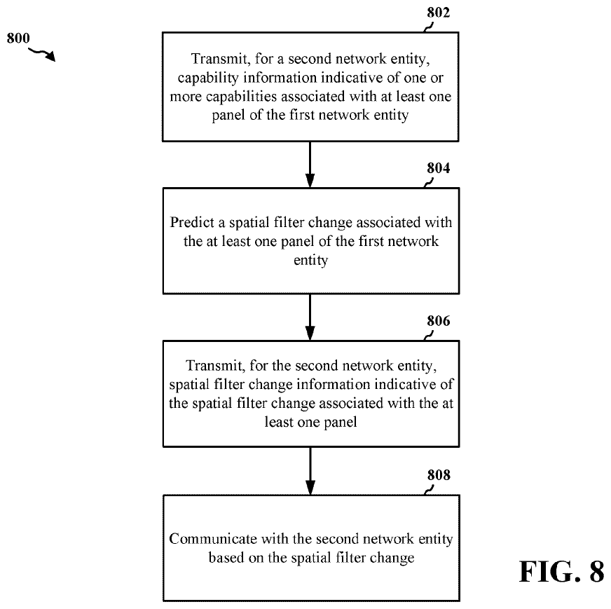

FIG. 8 is a flowchart 800 of a method of wireless communication. The method may be performed by first network entity, such as a UE (e.g., the UE 104, the UE 702, the apparatus 1004).

At 802, the first network entity may transmit, for a second network entity, capability information indicative of one or more capabilities associated with at least one panel of the first network entity. For example, the UE 702 may transmit, for a second network entity (e.g., network entity 704), capability information indicative of one or more capabilities (e.g., 706) associated with at least one panel of the first network entity. In some aspects, 802 may be performed by beam control component 198.

At 804, the first network entity may predict a spatial filter change associated with the at least one panel of the first network entity. For example, the UE 702 may predict (e.g., at 707) a spatial filter change associated with the at least one panel of the first network entity. In some aspects, 804 may be performed by beam control component 198. As used herein, the term “spatial filter change” may refer to a predicted or actual change related to a spatial filter for a transmission, such as a spatial filter change caused by a panel change. In some aspects, to predict the spatial filter change, the first network entity may predict the spatial filter change based on at least one of: at least one internal sensor at the first network entity, at least one camera at the first network entity, or at least one RS (e.g., such as a PRS, a CSI-RS, an SSB, or other RS). In some aspects, the first network entity may receive, from the second network entity or a third network entity, the at least one RS. In some aspects, the spatial filter change is associated with a DL transmission, an UL transmission, or an SL transmission.

At 806, the first network entity may transmit, for the second network entity, spatial filter change information indicative of the spatial filter change associated with the at least one panel. For example, the UE 702 may transmit, for the second network entity, spatial filter change information indicative (e.g., 708) of the spatial filter change associated with the at least one panel. In some aspects, 806 may be performed by beam control component 198. In some aspects, to transmit the spatial filter change information, the first network entity may transmit the spatial filter change information in a MAC-CE report based on a SR or transmit the spatial filter change information in a physical layer spatial filter report (e.g., a periodic, semi-persistent, or aperiodic physical layer spatial filter report). In some aspects, the MAC-CE is multiplexed with at least one other UL transmission. In some aspects, the SR is based on a PUCCH, a PSCCH, or a PSSCH, and the SR may be configured to be dedicated for the spatial filter change or independent of the spatial filter change. In some aspects, the SR is based on a random access procedure. In some aspects, the MAC-CE indicates at least one of: a future time (e.g., represented by a time stamp) associated with an applicability time for the spatial filter change, a mapping between an ID associated with the spatial filter change information or an RS ID and a panel ID of a first panel associated with the spatial filter change associated with the at least one panel, a representation of an available time or a blackout time when the first panel cannot be used. In some aspects, the spatial filter change information further includes a future time (e.g., represented by a time stamp) associated with the spatial filter change and at least one action at the first network entity or the second network entity. In some aspects, the at least one action includes at least one change associated with one or more of: a periodic or semi-persistent (P/SP) sounding reference signal (SRS), a configured grant (CG) physical uplink shared channel (PUSCH), a P/SP physical uplink control channel (PUCCH), a semi-persistent scheduling (SPS) physical downlink shared channel (PDSCH), a P/SP channel state information (CSI) reference signal (RS), or a P/SP tracking reference signal (TRS). In some aspects, the at least one change is one of a cancelation, a deactivation, or a port change. In some aspects, the spatial filter change information is associated with at least one of: an activated panel list change associated with the at least one panel, at least one capability change associated with the one or more capabilities, panel switching time information associated with the at least one panel, or a RS or channel association change representation associated with the at least one panel. In some aspects, each panel of the at least one panel is associated with one RS or one channel, and where the RS or channel association change representation associated with the at least one panel represents a change in an associated RS or an associated channel associated with a first panel of the at least one panel. In some aspects, the RS or channel association change representation further includes a time associated with the change in the associated RS or the associated channel. In some aspects, each panel of the at least one panel is associated with one RS or one channel, and where the RS or channel association change representation associated with the at least one panel represents a change in an associated RS or an associated channel associated with a first panel of the at least one panel. In some aspects, the spatial filter change information is associated with a blackout time when a first panel of the at least one panel cannot be used. In some aspects, the spatial filter change information indicates a second filter change at the second network entity.

At 808, the first network entity may communicate with the second network entity based on the spatial filter change. For example, the UE 702 may communicate (e.g., 716) with the second network entity based on the spatial filter change. In some aspects, 808 may be performed by beam control component 198.

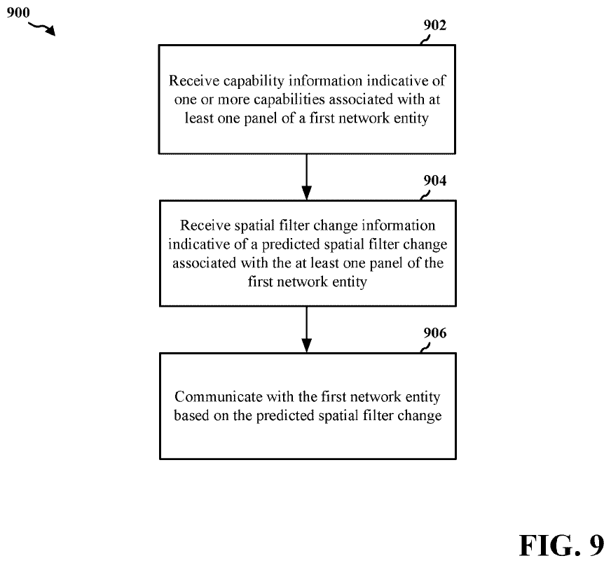

FIG. 9 is a flowchart 900 of a method of wireless communication. The method may be performed by a second network entity, such as a network entity (e.g., the base station 102, the network entity 704, the network entity 1002, the network entity 1102).

At 902, the second network entity may receive capability information indicative of one or more capabilities associated with at least one panel of a first network entity. For example, the network entity 704 may receive capability information indicative of one or more capabilities (e.g., 706) associated with at least one panel of a first network entity. In some aspects, 902 may be performed by beam control component 199.

At 904, the second network entity may receive spatial filter change information indicative of a predicted spatial filter change associated with the at least one panel of the first network entity. For example, the network entity 704 may receive spatial filter change information (e.g., 708) indicative of a predicted spatial filter change associated with the at least one panel of the first network entity. In some aspects, 904 may be performed by beam control component 199. In some aspects, to receive the spatial filter change information, the first network entity may receive the spatial filter change information in a MAC-CE report based on a SR or receive the spatial filter change information in a periodic physical layer spatial filter report. In some aspects, the MAC-CE is multiplexed with at least one other UL transmission. In some aspects, the SR is based on a PUCCH, a PSCCH, or a PSSCH, and the SR may be configured to be dedicated for the spatial filter change or independent of the spatial filter change. In some aspects, the SR is based on a random access procedure. In some aspects, the MAC-CE indicates at least one of: a future time (e.g., represented by a time stamp) associated with an applicability time for the spatial filter change, a mapping between an ID associated with the spatial filter change information or an RS ID and a panel ID of a first panel associated with the spatial filter change associated with the at least one panel, a representation of an available time or a blackout time when the first panel cannot be used. In some aspects, the spatial filter change information further includes a future time (e.g., represented by a time stamp) associated with the spatial filter change and at least one action at the first network entity or the second network entity. In some aspects, the at least one action includes at least one change associated with one or more of: a periodic or semi-persistent (P/SP) sounding reference signal (SRS), a configured grant (CG) physical uplink shared channel (PUSCH), a P/SP physical uplink control channel (PUCCH), a semi-persistent scheduling (SPS) physical downlink shared channel (PDSCH), a P/SP channel state information (CSI) reference signal (RS), or a P/SP tracking reference signal (TRS). In some aspects, the at least one change is one of a cancelation, a deactivation, or a port change. In some aspects, the spatial filter change information is associated with at least one of: an activated panel list change associated with the at least one panel, at least one capability change associated with the one or more capabilities, panel switching time information associated with the at least one panel, or a RS or channel association change representation associated with the at least one panel. In some aspects, each panel of the at least one panel is associated with one RS or one channel, and where the RS or channel association change representation associated with the at least one panel represents a change in an associated RS or an associated channel associated with a first panel of the at least one panel. In some aspects, the RS or channel association change representation further includes a time associated with the change in the associated RS or the associated channel. In some aspects, each panel of the at least one panel is associated with one RS or one channel, and where the RS or channel association change representation associated with the at least one panel represents a change in an associated RS or an associated channel associated with a first panel of the at least one panel. In some aspects, the spatial filter change information is associated with a blackout time when a first panel of the at least one panel cannot be used. In some aspects, the spatial filter change information indicates a second filter change at the second network entity.

At 906, the second network entity may communicate with the first network entity based on the predicted spatial filter change. For example, the network entity 704 may communicate (e.g., 716) with the first network entity based on the predicted spatial filter change. In some aspects, 906 may be performed by beam control component 199.

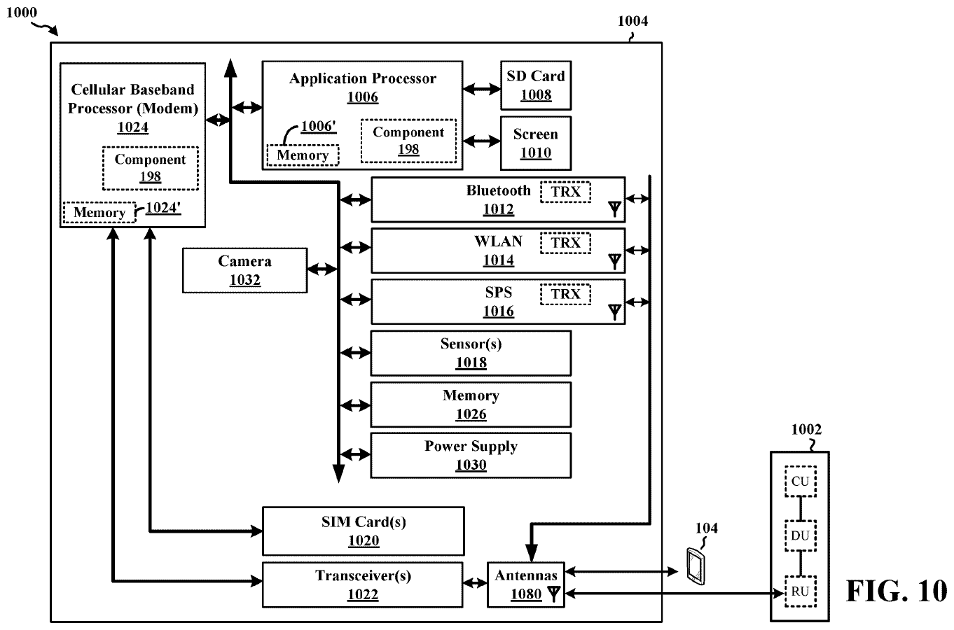

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, a satellite system module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the satellite system module 1016 may include an on-chip transceiver (TRX)/receiver (RX). The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described herein. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed herein, the beam control component 198 may be configured to transmit, for a second network entity, capability information indicative of one or more capabilities associated with at least one panel of the first network entity. In some aspects, the beam control component 198 may be further configured to predict a spatial filter change associated with the at least one panel of the first network entity. In some aspects, the beam control component 198 may be further configured to transmit, for the second network entity, spatial filter change information indicative of the spatial filter change associated with the at least one panel. In some aspects, the beam control component 198 may be further configured to communicate with the second network entity based on the spatial filter change. The beam control component 198 may be within the cellular baseband processor 1024, the application processor 1006, or both the cellular baseband processor 1024 and the application processor 1006. The beam control component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for transmitting, for a second network entity, capability information indicative of one or more capabilities associated with at least one panel of the first network entity. In some aspects, the apparatus 1004 may further include means for estimating a spatial filter change associated with the at least one panel of the first network entity. In some aspects, the apparatus 1004 may further include means for transmitting, for the second network entity, spatial filter change information indicative of the spatial filter change associated with the at least one panel. In some aspects, the apparatus 1004 may further include means for communicating with the second network entity based on the spatial filter change. In some aspects, the means for estimating a spatial filter change associated with the at least one panel of the first network entity may further include means for estimating the spatial filter change based on at least one of: at least one internal sensor at the first network entity, at least one camera at the first network entity, or at least one reference signal (RS). In some aspects, the apparatus 1004 may further include means for receiving, from the second network entity or a third network entity, the at least one RS. In some aspects, the apparatus 1004 may further include means for transmitting the spatial filter change information in a medium access control (MAC) control element (MAC-CE) report based on a scheduling request (SR). In some aspects, the apparatus 1004 may further include means for transmitting the spatial filter change information in a periodic physical layer spatial filter report. The means may be the beam control component 198 of the apparatus 1004 configured to perform the functions recited by the means. As described herein, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

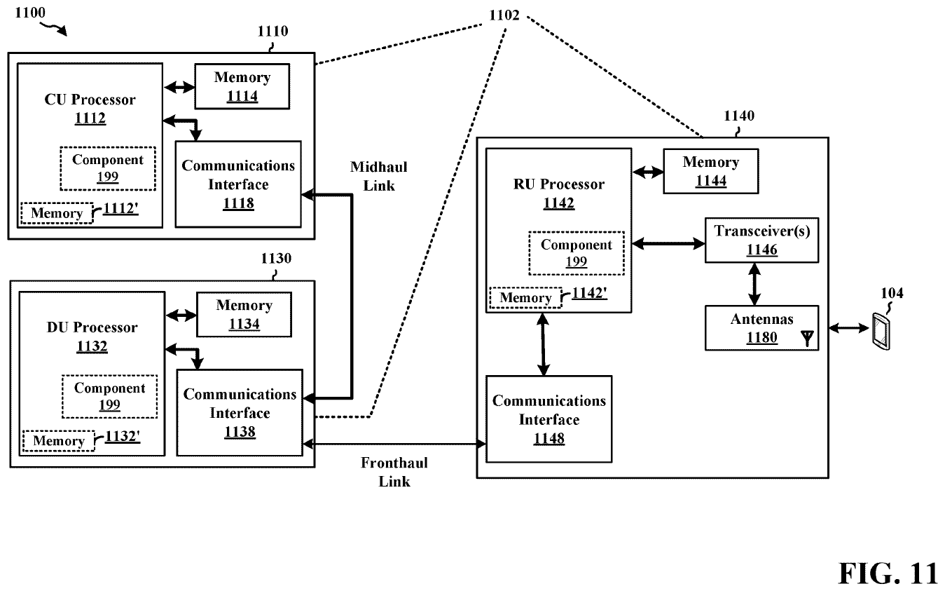

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the beam control component 199. In some aspects, the beam control component 199 may be configured to receive capability information indicative of one or more capabilities associated with at least one panel of a first network entity. In some aspects, the beam control component 199 may be further configured to receive spatial filter change information indicative of a predicted spatial filter change associated with the at least one panel of the first network entity. In some aspects, the beam control component 199 may be further configured to communicate with the first network entity based on the predicted spatial filter change. The beam control component 199 may be within one or more processors of one or more of the CU 1110, DU 1130, and the RU 1140. The beam control component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for receiving capability information indicative of one or more capabilities associated with at least one panel of a first network entity. In some aspects, the network entity 1102 may further include means for receiving spatial filter change information indicative of a predicted spatial filter change associated with the at least one panel of the first network entity. In some aspects, the network entity 1102 may further include means for communicating with the first network entity based on the predicted spatial filter change. In some aspects, the network entity 1102 may further include means for receiving the spatial filter change information in a medium access control (MAC) control element (MAC-CE) report based on a scheduling request (SR). In some aspects, the network entity 1102 may further include means for receiving the spatial filter change information in a periodic physical layer spatial filter report. The means may be the beam control component 199 of the network entity 1102 configured to perform the functions recited by the means. As described herein, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: transmit, for a second network entity, capability information indicative of one or more capabilities associated with at least one panel of the first network entity; predict a spatial filter change (e.g., spatial filter change caused by a panel change associated with the at least one panel) associated with the at least one panel of the first network entity; transmit, for the second network entity, spatial filter change information indicative of the spatial filter change associated with the at least one panel; and communicate with the second network entity based on the spatial filter change.

Aspect 2 is the first network entity of aspect 1, where to predict the spatial filter change, the at least one processor is configured to predict the spatial filter change based on at least one of: at least one internal sensor at the first network entity, at least one camera at the first network entity, or at least one reference signal (RS).

Aspect 3 is the first network entity of any of aspects 1-2, where the at least one processor is configured to: receive, from the second network entity or a third network entity, the at least one reference signal (RS).

Aspect 4 is the first network entity of any of aspects 1-3, where the spatial filter change is associated with a DL transmission, an UL transmission, or an SL transmission.

Aspect 5 is the first network entity of any of aspects 1-4, where to transmit the spatial filter change information, the at least one processor is configured to: transmit, based on a SR, the spatial filter change information in a MAC-CE report; or transmit the spatial filter change information in a physical layer spatial filter report.

Aspect 6 is the first network entity of aspect 5, where the MAC-CE is multiplexed with at least one other UL transmission.

Aspect 7 is the first network entity of aspect 5, where the SR is based on a physical uplink control channel (PUCCH), and where the SR is configured to be dedicated for the spatial filter change or independent of the spatial filter change.

Aspect 8 is the first network entity of aspect 5, where the SR is based on a random access procedure.

Aspect 9 is the first network entity of aspect 5, where the MAC-CE indicates at least one of: a future time (e.g., represented by a time stamp) associated with an applicability time for the spatial filter change, a mapping between an identifier (ID) associated with the spatial filter change information or a RS ID and a panel ID of a first panel associated with the spatial filter change associated with the at least one panel, a representation of an available time or a blackout time when the first panel cannot be used.

Aspect 10 is the first network entity of any of aspects 1-9, where the spatial filter change information further includes a future time (e.g., represented by a time stamp) associated with the spatial filter change and at least one action at the first network entity or the second network entity.

Aspect 11 is the first network entity of aspect 10, where the at least one action includes at least one change associated with one or more of: a periodic or semi-persistent (P/SP) sounding reference signal (SRS), a configured grant (CG) physical uplink shared channel (PUSCH), a P/SP physical uplink control channel (PUCCH), a semi-persistent scheduling (SPS) physical downlink shared channel (PDSCH), a P/SP channel state information (CSI) RS, or a P/SP tracking reference signal (TRS).

Aspect 12 is the first network entity of aspect 11, where the at least one change is one of a cancelation, a deactivation, or a port change.

Aspect 13 is the first network entity of any of aspects 1-12, where the spatial filter change information is associated with at least one of: an activated panel list change associated with the at least one panel, at least one capability change associated with the one or more capabilities, panel switching time information associated with the at least one panel, or a RS or channel association change representation associated with the at least one panel.

Aspect 14 is the first network entity of aspect 13, where each panel of the at least one panel is associated with one RS or one channel, and where the RS or channel association change representation associated with the at least one panel represents a change in an associated RS or an associated channel associated with a first panel of the at least one panel.

Aspect 15 is the first network entity of aspect 14, where the RS or channel association change representation further includes a time associated with the change in the associated RS or the associated channel.

Aspect 16 is the first network entity of aspect 13, where each panel of the at least one panel is associated with one RS or one channel, and where the RS or channel association change representation associated with the at least one panel represents a change in an associated RS or an associated channel associated with a first panel of the at least one panel.

Aspect 17 is the first network entity of any of aspects 1-16, where the spatial filter change information is associated with a blackout time when a first panel of the at least one panel cannot be used.

Aspect 18 is the first network entity of any of aspects 1-17, where the spatial filter change information indicates a second filter change at the second network entity.

Aspect 19 is the first network entity of any of aspects 1-18, where the first network entity is a first user equipment (UE), and where the second network entity is a second UE or a base station.

Aspect 20 is a second network entity for wireless communication, including: a memory; and at least one processor coupled to the memory, where the at least one processor is configured to: receive capability information indicative of one or more capabilities associated with at least one panel of a first network entity; receive spatial filter change information indicative of a predicted spatial filter change (e.g., spatial filter change caused by a panel change associated with the at least one panel) associated with the at least one panel of the first network entity; and communicate with the first network entity based on the predicted spatial filter change.

Aspect 21 is the second network entity of aspect 20, where the predicted spatial filter change is associated with a DL transmission, an UL transmission, or an SL transmission.

Aspect 22 is the second network entity of any of aspects 20-21, where to receive the spatial filter change information, the at least one processor is configured to: receive, based on a SR, the spatial filter change information in a MAC-CE report; or receive the spatial filter change information in a physical layer spatial filter report.

Aspect 23 is the second network entity of any of aspects 20-22, where the MAC-CE is multiplexed with at least one other UL transmission.

Aspect 24 is the second network entity of any of aspects 20-23, where the SR is based on a physical uplink control channel (PUCCH), and where the SR is configured to be dedicated for the predicted spatial filter change or independent of the predicted spatial filter change.

Aspect 25 is the second network entity of any of aspects 20-24, where the SR is based on a random access procedure.

Aspect 26 is the second network entity of any of aspects 20-25, where the MAC-CE indicates at least one of: a future time associated with an applicability time for the predicted spatial filter change, a mapping between an identifier (ID) associated with the spatial filter change information or a RS ID and a panel ID of a first panel associated with the predicted spatial filter change associated with the at least one panel, a representation of an available time or a blackout time when the first panel cannot be used.

Aspect 27 is the second network entity of any of aspects 20-26, where the spatial filter change information further includes a future time associated with the predicted spatial filter change and at least one action at the first network entity or the second network entity.

Aspect 28 is the second network entity of any of aspects 20-27, where the first network entity is a first user equipment (UE), and where the second network entity is a second UE or a base station.

Aspect 29 is a method of wireless communication for implementing any of aspects 1 to 19.

Aspect 30 is an apparatus for wireless communication including means for implementing any of aspects 1 to 19.

Aspect 31 is a computer-readable medium (e.g., a non-transitory computer-readable medium) storing computer executable code, where the code when executed by a processor causes the processor to implement any of aspects 1 to 19.

Aspect 32 is a method of wireless communication for implementing any of aspects 20 to 28.

Aspect 33 is an apparatus for wireless communication including means for implementing any of aspects 20 to 28.

Aspect 34 is a computer-readable medium (e.g., a non-transitory computer-readable medium) storing computer executable code, where the code when executed by a processor causes the processor to implement any of aspects 20 to 28.

1. A first network entity for wireless communication, comprising:
a memory; and
at least one processor coupled to the memory, wherein the at least one processor is configured to:
transmit, for a second network entity, capability information indicative of one or more capabilities associated with at least one panel of the first network entity;
predict a spatial filter change associated with the at least one panel of the first network entity;
transmit, for the second network entity, spatial filter change information indicative of the spatial filter change associated with the at least one panel; and
communicate with the second network entity based on the spatial filter change.

2. The first network entity of claim 1, wherein to predict the spatial filter change, the at least one processor is configured to estimate the spatial filter change based on at least one of: at least one internal sensor at the first network entity, at least one camera at the first network entity, or at least one reference signal (RS).

3. The first network entity of claim 2, wherein the at least one processor is configured to:
receive, from the second network entity or a third network entity, the at least one RS.

4. The first network entity of claim 1, wherein the spatial filter change is associated with a downlink (DL) transmission, an uplink (UL) transmission, or a sidelink (SL) transmission.

5. The first network entity of claim 1, wherein to transmit the panel change information, the at least one processor is configured to:
transmit, based on a scheduling request (SR), the spatial filter change information in a medium access control (MAC) control element (MAC-CE) report; or
transmit the spatial filter change information in a physical layer spatial filter report.

6. The first network entity of claim 5, wherein the MAC-CE is configured to be multiplexed with at least one other uplink (UL) transmission.

7. The first network entity of claim 5, wherein the SR is based on a physical uplink control channel (PUCCH), and wherein the SR is configured to be dedicated for the spatial filter change or independent of the spatial filter change.

8. The first network entity of claim 5, wherein the SR is based on a random access procedure.

9. The first network entity of claim 5, wherein the MAC-CE indicates at least one of: a future time associated with an applicability time for the spatial filter change, a mapping between an identifier (ID) associated with the spatial filter change information or a reference signal (RS) ID and a panel ID of a first panel associated with the spatial filter change associated with the at least one panel, a representation of an available time or a blackout time when the first panel cannot be used.

10. The first network entity of claim 1, wherein the indication further comprises a future time associated with the spatial filter change and at least one action at the first network entity or the second network entity.

11. The first network entity of claim 10, wherein the at least one action comprises at least one change associated with one or more of: a periodic or semi-persistent (P/SP) sounding reference signal (SRS), a configured grant (CG) physical uplink shared channel (PUSCH), a P/SP physical uplink control channel (PUCCH), a semi-persistent scheduling (SPS) physical downlink shared channel (PDSCH), a P/SP channel state information (CSI) reference signal (RS), or a P/SP tracking reference signal (TRS).

12. The first network entity of claim 11, wherein the at least one change is one of a cancelation, a deactivation, or a port change.

13. The first network entity of claim 1, wherein the spatial filter change information is associated with at least one of: an activated panel list change associated with the at least one panel, at least one capability change associated with the one or more capabilities, panel switching time information associated with the at least one panel, or a reference signal (RS) or channel association change representation associated with the at least one panel.

14. The first network entity of claim 13, wherein each panel of the at least one panel is associated with one RS or one channel, and wherein the RS or channel association change representation associated with the at least one panel represents a change in an associated RS or an associated channel associated with a first panel of the at least one panel.

15. The first network entity of claim 14, wherein the RS or channel association change representation further comprises a time associated with the change in the associated RS or the associated channel.

16. The first network entity of claim 13, wherein each panel of the at least one panel is associated with one RS or one channel, and wherein the RS or channel association change representation associated with the at least one panel represents a change in an associated RS or an associated channel associated with a first panel of the at least one panel.

17. The first network entity of claim 1, wherein the spatial filter change information is associated with a blackout time when a first panel of the at least one panel cannot be used.

18. The first network entity of claim 1, wherein the spatial filter change information indicates a second filter change at the second network entity.

19. The first network entity of claim 1, wherein the first network entity is a first user equipment (UE), and wherein the second network entity is a second UE or a base station.

20. The first network entity of claim 1, wherein the spatial filter change is caused by a panel change associated with the at least one panel.

21-30. (canceled)
